(19) United States
(12) Patent Application Publication
(10) Pub. No.: US 2010/0238311 A1
(43) Pub. Date: Sep. 23, 2010

(54) IMAGING DEVICE

(75) Inventors: Aleksey Kolesnychenko, Eindhoven (NL); Levinus Pieter Bakker, Eindhoven (NL); Frank Jeroen Pieter Schuurmans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/161,187

(22) PCT Filed: Jan. 16, 2007
(86) PCT No.: PCT/IB07/50137

§ 371 Date: Jul. 17, 2008

(30) Foreign Application Priority Data
Jan. 17, 2006 (EP) 06100417.2

(51) Int. Cl. H04N 5/228

(52) U.S. Cl. 348/222.1; 348/E05.031

(57) ABSTRACT

An imaging device for forming an image of a sample object includes an optical device and a processing unit. The optical device captures a Fourier spectrum of an object. The processing unit is arranged for processing the Fourier spectrum from the optical device and is adapted for determining the image of the sample object from the intensity of the Fourier spectrum of the sample object and the intensity of the Fourier spectrum of a combination of the sample object and a reference object.

### FIELD OF THE INVENTION

The invention relates to an imaging device for forming an image of a sample object and a method for forming an image.

### BACKGROUND OF THE INVENTION

There is a trend in life-science and the bio-medical field to move technologies from a laboratory use to in-field use. Laboratories in general use expensive equipment, whereas in-field use requires compact, automated and inexpensive devices. In said field many devices require imaging of biological samples with high resolution and large field. For example, the analysis of DNA requires imaging of a field of a few square millimetres with a resolution better than a few micrometers.

Currently there are two approaches to solve this imaging problem. The first approach uses a diffraction limited microscope objective, having the drawback that it is expensive. The second approach uses a scanning spot, which requires an accurate, expensive translation stage if the scanning spot is formed by a simple objective lens having a small field.

It is an object of the invention to provide a low-cost imaging device having good imaging properties.

### SUMMARY OF THE INVENTION

The object is met if, according to the invention, an imaging device for forming an image of a sample object includes an optical device for capturing a Fourier spectrum of an object and a processing unit for processing the Fourier spectrum, wherein the processing unit is adapted for determining the image of the sample object from the intensity of the Fourier spectrum of the sample object and the intensity of the Fourier spectrum of a combination of the sample object and a reference object.

The intensity of a Fourier spectrum of a sample object does in general not provide sufficient information to reconstruct an image of the sample object. The invention is based on the insight that the use of an additional object in the form of a reference object does allow the determination of an image of the sample object from the intensity of its Fourier spectrum.

The Fourier spectrum of the sample object is formed by an optical device and is processed by a processing unit. The processing unit may be a numerical computing device such as a PC. The determination of the image of the sample object from its Fourier spectrum requires the use of the reference object. The reference object has a known Fourier spectrum, obtained through e.g. calculation or measurement. The image of the sample object can now be determined from a first Fourier spectrum of the sample object and a second Fourier spectrum of a combination of the sample object and the reference object. The two-step process of forming the Fourier spectrum and processing the Fourier spectrum to an image appears to be have a reduced sensitive to certain optical aberrations in the formation of the Fourier spectrum caused by the optical device. Therefore, the image of the sample object is of a higher quality than would be expected from the quality of the optical device. The optical device may use low-cost optical components without sacrificing image quality.

In a preferred embodiment of the imaging device the processing unit is adapted for determining a phase of the Fourier spectrum of the sample object from the intensity of the Fourier spectrum of the sample object and the intensity of the Fourier spectrum of a combination of the sample object and the reference object, and for determining the image of the sample object from the intensity of the Fourier spectrum of the sample object and said phase. Combining the intensity of the first Fourier spectrum and the intensity of the second Fourier spectrum allows the calculation of the phase of the Fourier spectrum of the sample object. Once the phase and the intensity of the Fourier spectrum of the sample object are known, the image of the sample object can be reconstructed by an inverse Fourier transformation.

In a special embodiment of the imaging device the processing unit is adapted to fit the intensity of the Fourier spectrum of the reference object to a theoretical intensity distribution and use this fit for improving the determination of the image of the sample object. In this embodiment the intensity of a measured third Fourier spectrum of the reference object is fitted to the calculated Fourier spectrum of the reference object. Any deviations in the formation of the Fourier spectrum will appear as distortion in the intensity profile of the Fourier spectrum of the reference object. The fit will reveal and quantify such transverse aberrations. These aberrations can be used in the processing of the first and second Fourier spectrum to reduce the effect of the aberrations, thereby improving the quality of the image even further. Whereas the reconstruction of an image of a sample object requires two Fourier spectra to be formed of each sample object, the transverse aberration need be determined only once for an optical system.

The optical device preferably includes a coherent radiation source for illuminating at least one of the objects, an optical system for forming the Fourier spectrum of the object and a radiation detection system for capturing the Fourier spectrum. The optical system may comprise one or more components, such as e.g. lenses and mirrors.

In a special embodiment of the imaging device the optical system includes a field flattener. The field flattener flattens the plane in which the Fourier spectrum is formed, thereby improving the capture of the Fourier spectrum by the detection system.

A special embodiment of the optical device includes a first path and a different second path between the radiation source and the imaging device, the sample object being arrangeable in radiation having followed the first path and the reference object in radiation having followed the second path.

A positioning element may be used to arrange the detection system in a Fourier plane of the optical system.

The processing unit may be arranged to provide a contrast signal for controlling the positioning element, and the contrast signal may be derived from the intensity of high spatial frequencies in the sample object.

A second aspect of the invention relates to a method for forming an image of a sample object, including the steps of optically transforming the sample object to a first Fourier spectrum, optically transforming a combination of the sample object and a reference object to a second Fourier spectrum, and determining the image of the sample object by processing the intensity of the first Fourier spectrum and the intensity of the second Fourier spectrum.

The method preferably includes the steps of determining the phase of the Fourier spectrum of the sample object from the intensity of the first Fourier spectrum and the intensity of the second Fourier spectrum, and determining the image of the sample object from the intensity of the second Fourier spectrum and said phase.

A special embodiment of the method includes the steps of optically transforming the reference object to a third Fourier spectrum, fitting the intensity of the third Fourier spectrum to a theoretical intensity distribution, using the fit for improving the determination of the image of the sample object.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a first embodiment of the imaging device,

FIG. 2 shows a design of the optical system in the imaging device,

FIGS. 3A and B show a sample object and a reference object,

FIG. 4 shows a second embodiment of the imaging device,

FIG. 5 shows a third embodiment of the imaging device, and

FIG. 6 shows a fourth embodiment of the imaging device.

### DETAILED DESCRIPTION OF THE INVENTION

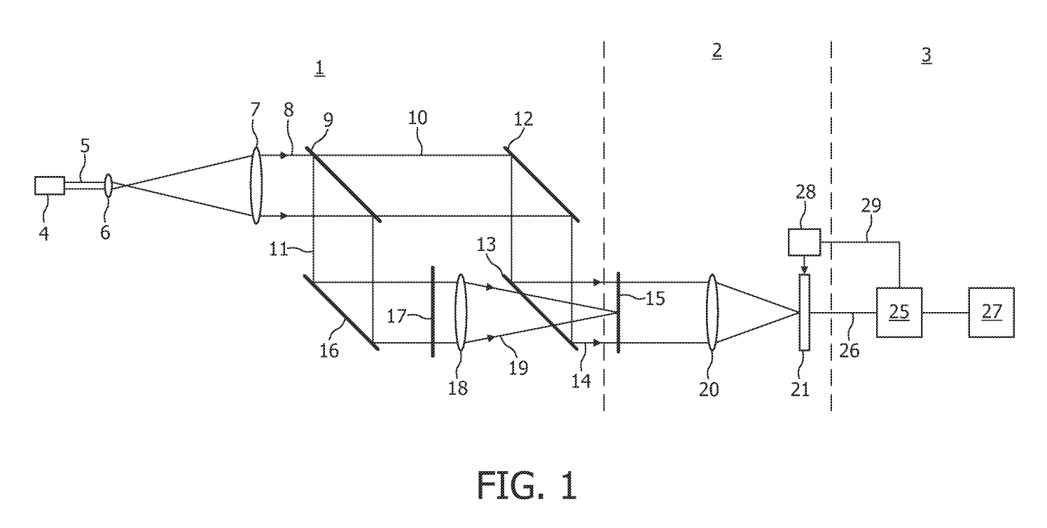

FIG. 1 shows a first embodiment of the imaging device according to the invention, wherein an object is illuminated in transmission. The imaging device can be divided in an optical device, including an illumination system 1 and a Fourier transform system 2, and a data processing system 3.

The illumination system 1 comprises a radiation source 4, preferably a coherent source such as a laser, emitting at a wavelength of e.g. 632 nm or 405 nm. A parallel beam 5 is expanded in diameter by a beam expander comprising lenses 6 and 7. An expanded parallel beam 8 at the output of the beam expander is divided by a beam splitter 9 into a first beam 10 and a second beam 11, following a first path and a second path, respectively. A folding mirror 12 and a beam combiner 13, e.g. a semi-transparent mirror, deflect the beam to a parallel beam 14 for illuminating an object plane 15. A folding mirror 16 deflects the beam second beam 11 to a shutter 17 and a lens 18. The shutter may be arranged anywhere between the beam splitter 9 and the beam combiner 13. The lens 18 transforms the second beam 11 to a converging beam 19 focused onto the object plane 15. By opening and closing the shutter an operator can control whether the object plane is illuminated by the parallel beam 14 only or by both the parallel beam 14 and the converging beam 19. An object such as a sample object and/or a reference object may be arranged in the object plane.

The Fourier transform system 2 comprises the object plane 15 illuminated by the illumination system 1. An object in the object plane in this embodiment of the imaging device is at least partly transparent. An optical system 20 forms a Fourier spectrum of an object in the object plane 15. The optical system may be a Fourier lens 20 as shown in FIG. 1. The intensity of the Fourier spectrum of the object is captured by a radiation detection system 21. The radiation detection system may be a square CCD detector.

The data processing system 3 comprises a processing unit 25 for processing electrical output signals 26 of the detection system 21. The result of the processing, e.g. a reconstructed image of the object, can be viewed on a display 27.

Since an image is only obtained after processing two Fourier spectra, direct observation of the image cannot easily be used for positioning of the detection system 21. Therefore, the Fourier transform system 2 may be provided with a positioning element 28 for positioning the detection system in the Fourier plane of the optical system 20 and controlled by a control signal 29 from the processing unit 25. The control signal may be derived from a contrast signal that measures the intensity of the higher spatial frequencies in the Fourier spectrum. A feedback loop must control the position of the detection system such that the contrast is maximized. In another embodiment the positioning is based on observation of images of the sample object calculated from only a part, e.g. the central part, of the Fourier spectrum, which provides an image in a shorter time, albeit of a reduced quality.

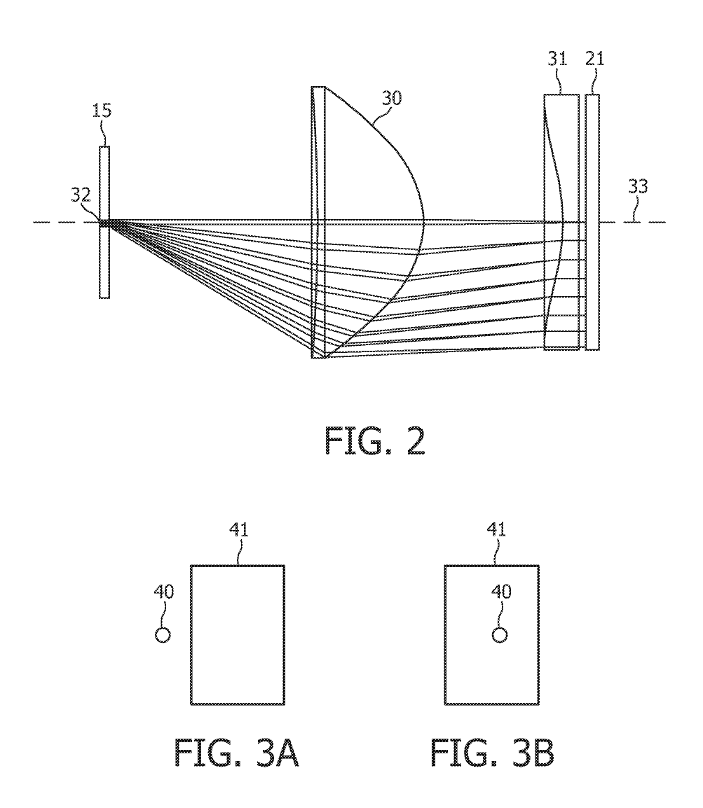

FIG. 2 shows a specific design of the optical system 20 of the optical device 2. The optical system comprises two components, a lens 30 and a field flattener 31. The design of the optical system can be relatively simple because of the less stringent requirements imposed on the element. The field 32 of the lens 30, i.e. the size of the object from which the lens forms a Fourier spectrum, is 650 micrometer. The lens 30 captures plane waves emanating from the object at different angles as drawn in FIG. 2 within a numerical aperture (NA) of 0.6. Each plane wave uses only a small fraction of the cross-section of each of the components. The optical system must be optimized to focus each of these plane waves as a cone of rays at the detection system 15. A typical numerical aperture (NA) of a cone of radiation focused on the detection system is 0.0125, yielding a low spatial resolution at the position of the detection system of ˜λ/NA equal to about 30 micrometer. Since the detection system has a size of 33 by 33 mm, approximately a thousand independent intensity values of plane waves can be measured in one dimension, corresponding to a CCD detection system of 1000×1000 detector elements or pixels. This yields a spatial resolution at the position of the object of one thousandth of the size of the field, i.e. 650 nm, which is approximately equal to the resolution λ/NA of the lens 30, being 405/0.60 nm.

The lens 30 of the embodiment shown is a concave-convex aspheric lens made of COC. The field flattener is a plano concave lens of BK7 glass.

A sample object to be imaged is arranged in the field 32 of the lens 30 in the object plane 15. The method for forming an image of the sample object comprises the following steps.

In the first step the shutter 17 in the second beam 11 is closed. The sample object is now illuminated by the parallel beam 14 only. The intensity of the first Fourier spectrum of the sample object is detected by the detection system 21 and stored digitally in the processing unity 25. In the second step the shutter 17 is opened, causing a brightly illuminated spot in the field 32. This spot forms a reference object having a known Fourier spectrum. If the spot is sufficiently small, it may be positioned in the sample object and any information of the sample object present at the position of the spot will not influence the Fourier transform of the spot. The sample object is simultaneously illuminated by the parallel beam 14. The intensity of the second Fourier spectrum of the combination of the sample object and the reference object is measured by the detection system 21 and also digitally stored in the processing unit 25. In the third step the phase of the first Fourier spectrum of the sample object is determined from the measured first and second Fourier spectra. In the fourth step the image of the sample is reconstructed from the measured intensity of the first Fourier spectrum and the calculated phase of the first Fourier spectrum by an inverse Fourier transformation and displayed on the display 27.

The complex amplitude of the electric field pattern of the sample object is given by f(x,y), that of the reference object by h(x,y) and that of the combination of the sample object and the reference object by g(x,y)=f(x,y)+h(x,y). The amplitudes are taken close to the objects at the side of the optical system. The parameters x and y indicate the position in the plane of the object, both measured in units of length. The Fourier transform of the amplitudes f(x,y), g(x,y) and h(,x,y) is F(kₓ,k_{y}), G(kₓ,k_{y}) and H(kₓ,k_{y}), respectively. The parameters kₓ and k_{y} are the spatial frequencies in the x and y direction, both measured in units of length⁻¹. Each detector element of the detection system 21 corresponds to a specific value of kₓ and k_{y}. The Fourier transform of F and H can be written as a product of an amplitude |F|, |H| and a phase φ and θ, respectively:

F(kₓ,k_{y})=|F(kₓ,k_{y}|e^{iφ(k}^{ₓ}^{,k}^{_{y}}⁾

H(kₓ,k_{y})=|H(kₓ,k_{y}|e^{iθ(k}^{ₓ}^{,k}^{_{y}}⁾

From the equation

G(kₓ,k_{y})=F(kₓ,k_{y})+H(kₓ,k_{y})

the value of |G(kₓ,k_{y})|², representing the intensity of the Fourier spectrum G, can be calculated. The expression for |G(kₓ,k_{y})|² can be rewritten to

$$cos ( ϕ - θ ) = \frac{{\vert G ( {k}_{x} , {k}_{y} ) \vert}^{2} - {\vert F ( {k}_{x} , {k}_{y} ) \vert}^{2} - {\vert H ( {k}_{x} , {k}_{y} ) \vert}^{2}}{2 \vert F ( {k}_{x} , {k}_{y} ) \vert \vert H ( {k}_{x} , {k}_{y} ) \vert} \qquad eq . ( 1 )$$

|F(kₓ,k_{y})|² is the intensity of the Fourier transform of the sample object only, measured by the detection system. |G(kₓ,k_{y})|² is the intensity of the Fourier transform of the combination of the sample object and the reference object, also measured by the detection system. |H(kₓ,k_{y})|² is the intensity of the Fourier transform of the reference object, which can be calculated from the properties of the reference object or can be determined in a separate measurement of the Fourier transform of the reference object only. The phase θ is determined from the calculated Fourier transform of the reference object.

The phase φ can now be calculated for each pair of kₓ and k_{y} corresponding to a detector element of the detection system 21 by inserting the intensity values, their square roots and the phase θ, all pertaining to said detector element, in the above equation (1). Since for each detector element in the Fourier plane both the amplitude |F| and the phase φ are known, an inverse Fourier transform provides the complex amplitude f(x,y) of the object. The image is obtained by calculating |f(x,y)|² for each desired position x,y.

The reference object may be an object 40 separate from the sample object 41, both arranged in the plane of the object 15, as shown in FIG. 3A. The reference object may also overlay the sample object or form part of the sample object, as shown in FIG. 3B. In the case of FIG. 3B the sample object must be sufficiently small so that any information of the sample within the area of the reference object does not affect the Fourier spectrum of the reference object other than the average intensity of the Fourier spectrum. This can be achieved by a small reference object or a sample object having little information in the area of the reference object. The reference object may be a radiation spot having a uniform intensity or a well-defined position-dependent intensity. The radiation emanating from the reference object preferably fills the NA of the optical system 20 on the side of the object to be able to calculate an accurate value of θ over the entire Fourier plane. Where the reference object is a focal spot of a converging beam, such as beam 19 in FIG. 1, the NA of the converging beam is therefore preferably equal to the NA of the optical system 20. The intensity of the reference object and the sample object must allow measurement of the difference between F and G. In view of the dynamic range and noise properties of the detection system, the difference between F and G should not be too large or too small. Preferably, both F and H should cover half of the dynamic range of the detection system.

The reference object must allow the determination of its Fourier spectrum H. The intensity |H|² can be measured in an imaging device as shown in FIG. 1 whereby the beam 10 can be blocked. With the shutter 17 open the detection system 21 captures the required intensity of the Fourier spectrum. Another method of determining |H|² is by calculating the Fourier transform of the reference object, starting from the amplitude of the reference object and using the properties of the optical system 20. The intensity values can be stored in an array. For simple reference objects the intensity can be an analytical solution of the Fourier spectrum. The phase θ of the Fourier spectrum H can be determined from the calculated Fourier transform of the reference spectrum.

Preferably the optical aberrations of the optical system 20 are taken into account in the above calculations of the Fourier spectrum H. The aberrations may be determined from the design of the system or from a direct measurement. In a first calculation H(aber) is determined for the optical system including the aberrations, in a second calculation H(ideal) is determined for the optical system without aberrations. The phase θ(aber) and θ(ideal) are derived from H(aber) and H(ideal), respectively. The phase φ(ideal) of the sample object is determined from the equation:

φ(ideal)=(φ(aber)−θ(aber))+θ(ideal) eq. (2)

The phase difference φ(aber)−θ(aber) is calculated with equation (1), using the values of H for an aberrated optical system 20. When the phase φ(ideal) is used in the inverse Fourier transformation to determine the image from the Fourier spectrum, any phase errors of the optical system are corrected to first order in the phase error of the optical system.

When the aberrations of the optical system 20 are relatively large, the cones of light in FIG. 2 may have a transverse aberration such that they do not focus anymore on the correct pixels of the detection system 21. In that case a special embodiment of the device can reduce the effect of the transverse aberration by carrying out several additional steps in the process of forming an image. A Fourier spectrum is made of the reference source only and measured by the detection system, as described above. The intensity of the Fourier spectrum, |H|², is stored in the processing unit 25. The Fourier spectrum of the reference source is also calculated for the optical system without aberrations, i.e. by a Fourier transform using an ideal lens function. A fit of the calculated Fourier spectrum to the measured Fourier spectrum will provide data on the distortion of the spectrum in both kₓ and k_{y}. The measured Fourier spectra F and G can be corrected for the distortion using these data.

The transverse aberrations of the optical system 20 can also be taken into account by calculating the distortion in the Fourier plane by ray-tracing and therewith correcting the measured Fourier spectra F and G using standard methods.

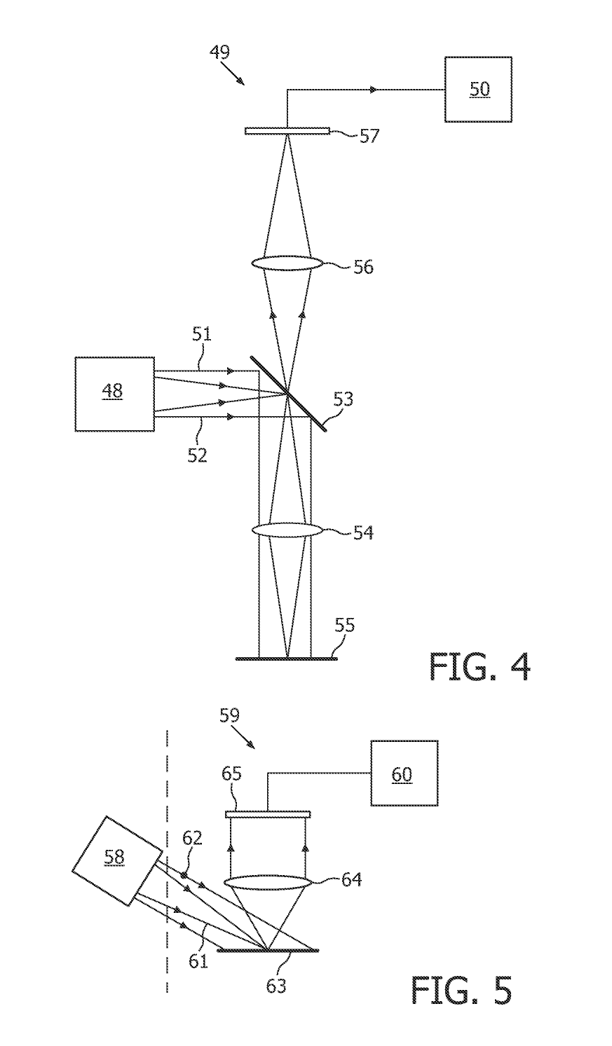

FIG. 4 shows a second embodiment of the imaging device in which the sample object is illuminated in reflection. The imaging device includes an illumination system 48, a Fourier transform system 49 and a data processing system 50. The illumination system 48 is the similar to the illumination system 1 shown in FIG. 1, apart from the shutter 17, which is arranged in the first optical path. The data processing system 52 is the same as the data processing system 3 shown in FIG. 1.

A parallel beam 51 from the illumination system is deflected by a beam splitter 53 and focused by an optical system 54 in an object plane 55. The focus of the beam 51 in the object plane operates as the reference object. The intensity of the reference object can be switched on and off by the shutter 17. A converging beam 52 from the illumination system is also deflected by the beam splitter and converted to a parallel beam by the optical system 54, for illuminating the sample object, which can be arranged in the object plane 55. The optical system 54 forms a Fourier spectrum of the object in its back focal plane, i.e. the plane through the centre of the beam splitter 53. An imaging lens 56 images the plane of the Fourier spectrum on the detection system 57.

FIG. 5 shows a third embodiment of the imaging device in which the object is illuminated in a dark-field manner. The imaging device includes an illumination system 58, a Fourier transform system 59 and a data processing system 60. The illumination system 58 is the same as the illumination system 1 shown in FIG. 1. The data processing system 60 is the same as the data processing system 3 shown in FIG. 1.

A converging beam 61 from the illumination system forms an illuminated spot in the object plane 63 acting as reference object. The sample object arranged in the object plane should provide sufficient scattering to fill the NA of the optical system 64. A parallel beam 62 from the illumination system illuminates a relatively large area of the object plane, on which the sample object may be arranged. The object plane 63 is in the focal plane of an optical system 64, which forms a Fourier spectrum of the object in its back focal plane, where a detection system 65 is arranged.

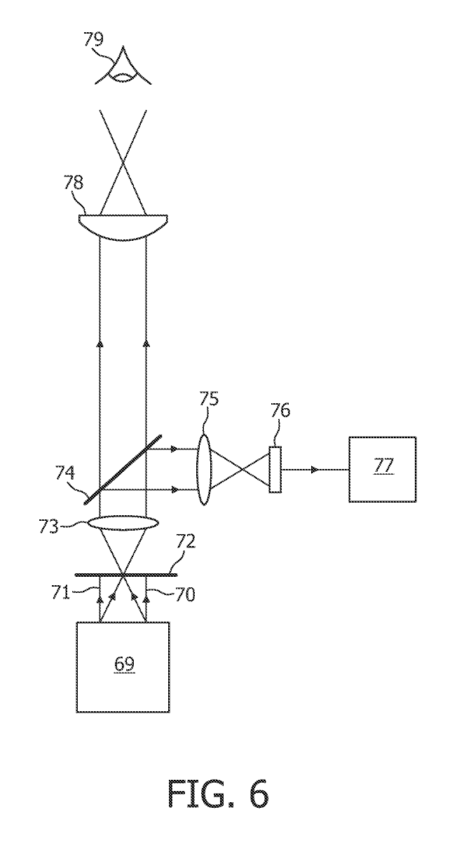

FIG. 6 shows a fourth embodiment of the imaging device incorporated in a microscope. An illumination system 69 generates a parallel beam 70 and a converging beam 71. The beam 71 can be switched on and off by a shutter in the illumination system. Both beams illuminate an object plane 72, on which a sample object may be arranged. An objective lens 73 collects radiation from the object. A beam splitter 74 reflects part of the radiation to a lens 75 that images the Fourier plane of the objective lens onto a detection system 76 connected to a data processing system 77. Radiation transmitted by the beam splitter is converged by an eyepiece 78 for inspection by an observer 79.

The imaging device according to the invention is eminently suitable in the general field of microscopy because of the enhanced quality of its images. It is particularly suitable for the investigation of biological samples. The imaging device may also be used in process control, such as used in the manufacture of semiconductor integrated devices. The large field of the device allows a faster processing of products, thereby reducing the cost of manufacture.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An imaging device for forming an image of a sample object, including an optical device for capturing a Fourier spectrum of an object and a processing unit for processing the Fourier spectrum, wherein the processing unit is adapted for determining the image of the sample object from the intensity of the Fourier spectrum of the sample object and the intensity of the Fourier spectrum of a combination of the sample object and a reference object.

2. An imaging device according to claim 1, wherein the processing unit is adapted for determining a phase of the Fourier spectrum of the sample object from the intensity of the Fourier spectrum of the sample object and the intensity of the Fourier spectrum of a combination of the sample object and the reference object, and for determining the image of the sample object from the intensity of the Fourier spectrum of the sample object and said phase.

3. An imaging device according to claim 1, wherein the processing unit is adapted to fit the intensity of the Fourier spectrum of the reference object to a theoretical intensity distribution and use this fit for improving the determination of the image of the sample object.

4. An imaging device according to claim 1, wherein the optical device includes a coherent radiation source for illuminating at least one of the objects, an optical system for forming the Fourier spectrum of the object and a radiation detection system for capturing the Fourier spectrum.

5. An imaging device according to claim 4, wherein the optical system includes a field flattener.

6. An imaging device according to claim 4, wherein the optical device includes a first path and a different second path between the radiation source and the imaging device, the sample object being arrangeable in radiation having followed the first path and the reference object in radiation having followed the second path.

7. An imaging device according to claim 4, including a positioning element for arranging the detection system in a Fourier plane of the optical system.

8. An imaging device according to claim 7, wherein the processing unit is arranged to provide a contrast signal for controlling the positioning element.

9. An imaging device according to claim 8, wherein the contrast signal is derived from the intensity of high spatial frequencies in the sample object.

10. A method for forming an image of a sample object, including the steps of:
optically transforming the sample object to a first Fourier spectrum,
optically transforming a combination of the sample object and a reference object to a second Fourier spectrum, and
determining the image of the sample object by processing the intensity of the first Fourier spectrum and the intensity of the second Fourier spectrum.

11. A method according to claim 10, wherein the processing includes the steps of:
determining the phase of the Fourier spectrum of the sample object from the intensity of the first Fourier spectrum and the intensity of the second Fourier spectrum, and
determining the image of the sample object from the intensity of the second Fourier spectrum and said phase.

12. A method according to claim 10, including the steps of:
optically transforming the reference object to a third Fourier spectrum,
fitting the intensity of the third Fourier spectrum to a theoretical intensity distribution,
using the fit for improving the determination of the image of the sample object.
